(19) United States
(12) Patent Application Publication
(10) Pub. No.: US 2024/0355197 A1
(43) Pub. Date: Oct. 24, 2024

(54) FILTERING DEVICE, FILTERING METHOD, AND NON-TRANSITORY RECORDING MEDIUM

(71) Applicant: Woven by Toyota, Inc., Tokyo (JP)

(72) Inventors: Masaki TAKANO, Tokyo (JP); Yusaku MANDAI, Tokyo (JP)

(73) Assignee: Woven by Toyota, Inc., Tokyo (JP)

(21) Appl. No.: 18/639,390

(22) Filed: Apr. 18, 2024

(30) Foreign Application Priority Data
Apr. 21, 2023 (JP) 2023-070329

(51) Int. Cl. G08G 1/01; G01S 7/48; G01S 7/497; G06T 7/70; G08G 1/052

(52) U.S. Cl. CPC G08G 1/0125; G01S 7/4802; G01S 7/497; G06T 7/70; G08G 1/0112; G06T 2207/30244; G08G 1/052

(57) ABSTRACT

A filtering device performing processing for excluding vehicle sensor data showing the results of detection of a vehicle sensor mounted in a probe vehicle includes a scoring processing part for scoring the vehicle sensor data, a determination part for comparing score of the vehicle sensor data and a first threshold value, and a filtering processing part for performing processing for excluding the vehicle sensor data based on the results of determination of the determination part.

### FIELD

The present disclosure relates to a filtering device, filtering method, and non-transitory recording medium.

### BACKGROUND

PTL 1 (Japanese Unexamined Patent Publication No. 2019-021221) describes the art of generating a travel route map based on probe information obtained by cameras and various sensors mounted in a vehicle. In the art described in PTL 1, the probe information is filtered based on the driving diagnosis results (score results). PTL 1 describes to calculate a frequency of sudden acceleration, a frequency of sudden braking, a frequency of sudden left turns/right turns, and a frequency of left-right wobbling from acceleration in the probe information, to give score so that the lower the frequency, the higher the score, and to calculate the total score. In the art described in PTL 1, when the total score is less than the passing score, it is presumed that the probe information shows dangerous driving and the probe information is not used for generating the travel route map.

In the art described in PTL 1, it is determined whether to exclude the probe information (vehicle sensor data showing results of detection of vehicle sensors) based on the frequency of the sudden acceleration, the frequency of the sudden braking, the frequency of the sudden left turns/right turns, and the frequency of left-right wobbling of the probe vehicle, but it is not determined whether to exclude the probe information based on information showing whether the probe vehicle committed a traffic rule violation. Further, in the art described in PTL 1, it is not determined whether to exclude the probe information based on information showing whether a lane departure warning is frequently issued in the probe vehicle. Further, in the art described in PTL 1, it is not determined whether to exclude the probe information based on a distance or a TTC (time to collision) between the probe vehicle and a preceding vehicle. For this reason, in the art described in PTL 1, the probe information is liable to not be suitably excluded.

### SUMMARY

In view of the above-mentioned score, the present disclosure has as its object the provision of filtering device, filtering method, and non-transitory recording medium enabling suitable exclusion of vehicle sensor data showing results of detection of a vehicle sensor mounted in a probe vehicle.

(1) One aspect of the present disclosure is a filtering device including a processor configured to: perform processing for excluding vehicle sensor data showing results of detection of a vehicle sensor mounted in a probe vehicle; score the vehicle sensor data, and compare score of the vehicle sensor data and a first threshold value, wherein the processor is configured to perform the processing for excluding the vehicle sensor data based on results of comparison of the score of the vehicle sensor data and the first threshold value, and the processor is configured to score the vehicle sensor data based on at least one of information showing whether the probe vehicle is a vehicle which committed a stop sign violation, information showing whether the probe vehicle is a vehicle which committed a speed limit violation, information showing whether a lane departure warning is frequently issued in the probe vehicle, and information showing whether a distance or a TTC between the probe vehicle and a preceding vehicle is a second threshold value or less.

(2) In the filtering device of the aspect (1), the processor may be configured to score the vehicle sensor data based on the information showing whether the probe vehicle is the vehicle which committed the stop sign violation, and when the probe vehicle is the vehicle which committed the stop sign violation, the processor may be configured to exclude the vehicle sensor data more easily than when the probe vehicle is not the vehicle which committed the stop sign violation.

(3) In the filtering device of the aspect (1) or (2), the processor may be configured to score the vehicle sensor data based on the information showing whether the probe vehicle is the vehicle which committed the speed limit violation, and when the probe vehicle is the vehicle which committed the speed limit violation, the processor may be configured to exclude the vehicle sensor data more easily than when the probe vehicle is not the vehicle which committed the speed limit violation.

(4) In the filtering device of any of the aspects (1) to (3), the processor may be configured to score the vehicle sensor data based on the information showing whether the lane departure warning is frequently issued in the probe vehicle, and when the lane departure warning is frequently issued in the probe vehicle, the processor may be configured to exclude the vehicle sensor data more easily than when the lane departure warning is not frequently issued in the probe vehicle.

(5) In the filtering device of any of the aspects (1) to (4), the processor may be configured to score the vehicle sensor data based on the information showing whether the distance or the TTC between the probe vehicle and the preceding vehicle is the second threshold value or less, and when the distance or the TTC between the probe vehicle and the preceding vehicle is the second threshold value or less, the processor is configured to exclude the vehicle sensor data more easily than when the distance or the TTC between the probe vehicle and the preceding vehicle is not the second threshold value or less.

(6) In the filtering device of any of the aspects (1) to (5), the vehicle sensor may include a front camera capturing an image of the front of the probe vehicle, the vehicle sensor data may include the image of the front of the probe vehicle captured by the front camera, and when the distance or the TTC between the probe vehicle and the preceding vehicle is the second threshold value or less, the image of the front of the probe vehicle captured by the front camera may include only the preceding vehicle or most of the image of the front of the probe vehicle captured by the front camera may show the preceding vehicle.

(7) In the filtering device of any of the aspects (1) to (6), the processor may be configured to determine whether a mounting position of the vehicle sensor is changed, and when the mounting position of the vehicle sensor is changed, the processor may be configured to perform processing for excluding vehicle sensor data after changing the mounting position which shows results of detection of the vehicle sensor after the mounting position is changed.

(8) In the filtering device according to the aspect (7), the vehicle sensor may include an in-vehicle camera capturing an image showing an external condition of the probe vehicle, the processor may be configured to determine whether the mounting position of the in-vehicle camera is changed based on an image after changing the mounting position which is an image showing the external condition of the probe vehicle captured by the in-vehicle camera after the mounting position is changed and an image before changing the mounting position which is an image showing the external condition of the probe vehicle captured by the in-vehicle camera before the mounting position changes, and the processor may be configured to perform processing for excluding the image after changing the mounting position when the mounting position of the in-vehicle camera is changed.

(9) In the filtering device of the aspect (7), the vehicle sensor may include a LiDAR having a function of recognizing an object outside the probe vehicle, the processor may be configured to determine whether a mounting position of the LiDAR is changed based on the results of object recognition performed by the LiDAR at the time of calibration of the LiDAR after the mounting position is changed and the results of object recognition performed by the LiDAR at the time of the calibration of the LiDAR before the mounting position is changed, and the processor may be configured to perform processing for excluding the results of object recognition performed by the LiDAR after determining that the mounting position of the LiDAR is changed when the processor determines that the mounting position of the LiDAR is changed.

(10) In the filtering device of any of the aspects (1) to (9), the vehicle sensor data which is not excluded by the processor may be used for at least one of generation of map information, generation of traffic information, and generation of information showing deteriorated condition of road surface.

(11) Another aspect of the present disclosure is a filtering method including: performing processing for excluding vehicle sensor data showing results of detection of a vehicle sensor mounted in a probe vehicle, scoring the vehicle sensor data, and comparing score of the vehicle sensor data and a first threshold value, wherein the processing for excluding the vehicle sensor data is performed based on results of comparison of the score of the vehicle sensor data and the first threshold value, and the vehicle sensor data is scored based on at least one of information showing whether the probe vehicle is a vehicle which committed a stop sign violation, information showing whether the probe vehicle is a vehicle which committed a speed limit violation, information showing whether a lane departure warning is frequently issued in the probe vehicle, and information showing whether a distance or a TTC between the probe vehicle and a preceding vehicle is a second threshold value or less.

(12) Another aspect of the present disclosure is a non-transitory recording medium having recorded thereon a computer program for causing a computer mounted in a probe vehicle or a computer forming a server device to execute a process including: scoring vehicle sensor data showing results of detection of a vehicle sensor mounted in the probe vehicle, comparing score of the vehicle sensor data and a first threshold value, and performing processing for excluding the vehicle sensor data based on the results of comparison of the score of the vehicle sensor data and the first threshold value, wherein the vehicle sensor data is scored based on at least one of information showing whether the probe vehicle is a vehicle which committed a stop sign violation, information showing whether the probe vehicle is a vehicle which committed a speed limit violation, information showing whether a lane departure warning is frequently issued in the probe vehicle, and information showing whether a distance or a TTC between the probe vehicle and a preceding vehicle is a second threshold value or less.

According to the present disclosure, it is possible to suitably exclude vehicle sensor data showing the results of detection of the vehicle sensor mounted in the probe vehicle.

### BRIEF DESCRIPTION OF DRAWINGS

FIG. 1 is a view showing a first example of a vehicle data utilization system 1 to which a filtering device C32 of a first embodiment is applied.

FIG. 2 is a view showing one example of the functions of a processor C3 shown in FIG. 1.

FIG. 3 is a flow chart for explaining one example of processing performed by the filtering device C32 of the first embodiment.

FIG. 4 is a view showing one example of the functions of a control part 12C of a server apparatus 12 of the vehicle data utilization system 1 to which a filtering device 2C2 of a second embodiment is applied.

### DESCRIPTION OF EMBODIMENTS

Below, referring to the drawings, embodiments of a filtering device, filtering method, and non-transitory recording medium of the present disclosure will be explained.

### First Embodiment

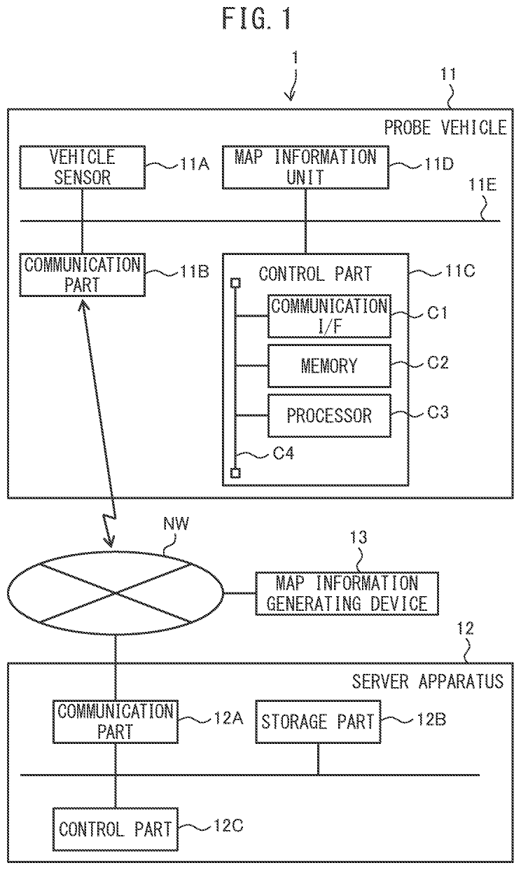

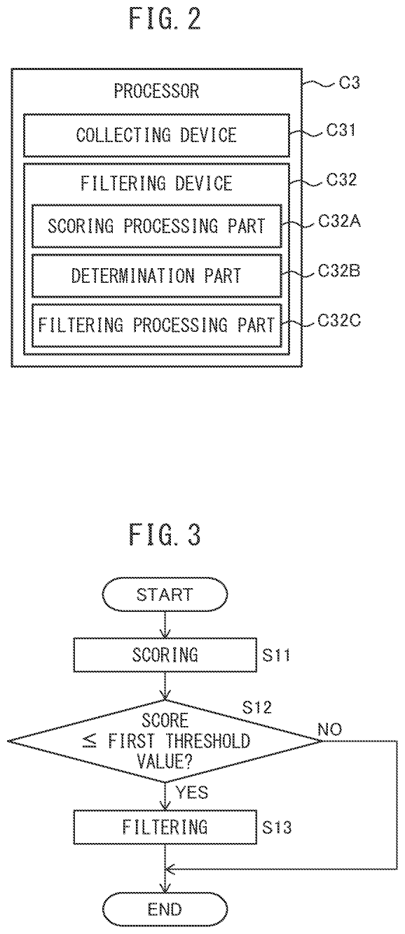

FIG. 1 is a view showing a first example of a vehicle data utilization system 1 to which a filtering device C32 of a first embodiment is applied. FIG. 2 is a view showing one example of the functions of a processor C3 shown in FIG. 1.

In the example shown in FIG. 1 and FIG. 2, the vehicle data utilization system 1 is a system for utilizing vehicle sensor data showing results of detection of a vehicle sensor 11A mounted in a probe vehicle 11. The vehicle data utilization system 1 includes, for example, the probe vehicle 11, server apparatus 12, and map information generating device 13.

The probe vehicle 11 is a vehicle linked with a network NW and is called a “connected car”. The probe vehicle 11, for example, is provided with the vehicle sensor 11A, communication part 11B, control part 11C, and map information unit 11D. The vehicle sensor 11A, the communication part 11B, the control part 11C, and the map information unit 11D are connected through an internal vehicle network 11E.

The vehicle sensor 11A, for example, includes in-vehicle camera capturing images showing the situation outside the probe vehicle 11 (for example, front camera, rear camera, side camera, or the like), radar, LiDAR (Light Detection And Ranging) having the function of recognizing objects outside the probe vehicle 11, or the like. Further, the vehicle sensor 11A, for example, may include various sensor for detecting data relating to travel situation of the probe vehicle 11 (for example, engine speed, operating state of accelerator/brake etc., vehicle speed, acceleration, shift position, travel distance, positional information, etc.) The positional information showing the current position of the probe vehicle 11 may be obtained by a GPS (global positioning system) module functioning as the vehicle sensor 11A receiving GPS signals. Furthermore, the vehicle sensor 11A, for example, may include various warning device for outputting warning, various diagnostic device for outputting results of diagnosis, etc.

The communication part 11B is, for example, configured by a DCM (data communication module). The communication part 11B has the function of sending the vehicle sensor data showing the results of detection of the vehicle sensor 11A through the network NW to the server apparatus 12. Further, the communication part 11B has the function of, for example, receiving map information generated by the map information generating device 13 etc. through the network NW.

The map information unit 11D is, for example, formed inside an HDD (hard disk drive), SSD (solid state drive), or other storage mounted in the probe vehicle 11. The map information possessed by the map information unit 11D includes the road structures (positions of roads, shapes of roads, lane structures, etc.), rules, and various other information.

The control part 11C has the function of making the communication part 11B send the vehicle sensor data to the server apparatus 12 etc. The control part 11C is configured by a computer provided with communication interface (I/F) C1, memory C2, and processor C3. The communication interface C1, memory C2, and processor C3 are connected through signal line C4. The communication interface C1 has an interface circuit for connecting the control part 11C to the internal vehicle network 11E. The memory C2 is one example of a storage part and, for example, has volatile semiconductor memory and nonvolatile semiconductor memory. The memory C2 stores programs used in processing performed by the processor C3 and various types of data. The processor C3 performs various types of processing (for example, processing for making the communication part 11B send the vehicle sensor data to the server apparatus 12 etc.) Further, the processor C3, for example, has the function of controlling steering actuator (not shown), braking actuator (not shown), and drive actuator (not shown) of the probe vehicle 11.

In the example shown in FIG. 1 and FIG. 2, the control part 11C is configured by an autonomous driving ECU (electronic control unit) and is able to control the probe vehicle 11 by a driving control level of level 3 defined by the SAE (Society of Automotive Engineers), that is, the driving control level not requiring operation by the driver of the steering actuator, the braking actuator, and the drive actuator and monitoring of surroundings of the probe vehicle 11. Further, the control part 11C has the function of controlling the probe vehicle 11 by the driving control level at which the driver is involved in driving of the probe vehicle 11, for example, the driving control level of levels 0 to 2 defined by the SAE. Further, the control part 11C, for example, has the function of making an HMI (human machine interface) (not shown) output a lane departure warning etc.

In another example, the control part 11C may not have the function of controlling the probe vehicle 11 by the driving control level of the level 3 defined by the SAE. That is, the probe vehicle 11 may be not an autonomous driving vehicle, but a manual driving vehicle.

Further, in another example, the control part 11C may not have the function of controlling the steering actuator, the braking actuator, and the drive actuator of the probe vehicle 11. That is, an ECU having the function of controlling the steering actuator, the braking actuator, and the drive actuator of the probe vehicle 11 may be provided in the probe vehicle 11 separate from the control part 11C having the function of making the communication part 11B send the vehicle sensor data to the server apparatus 12.

In the example shown in FIG. 1 and FIG. 2, the processor C3 has the function of a collecting device C31 and the function of a filtering device C32. The collecting device C31 collects the vehicle sensor data showing the results of detection of the vehicle sensor 11A from the vehicle sensor 11A.

The vehicle sensor data collected by the collecting device C31 from the vehicle sensor 11A may include, for example, the vehicle sensor data which is not appropriate for being utilized by the map information generating device 13 etc.

In view of this point, in the example shown in FIG. 1 and FIG. 2, the processor C3 has the function of the filtering device C32 which performs processing for excluding the vehicle sensor data showing the results of detection of the vehicle sensor 11A. The filtering device C32 is provided with scoring processing part C32A, determination part C32B, and filtering processing part C32C.

The scoring processing part C32A scores the vehicle sensor data collected by the collecting device C31 from the vehicle sensor 11A.

Specifically, the scoring processing part C32A scores the vehicle sensor data based on information showing whether the probe vehicle 11 is a vehicle which committed a stop sign violation. When the probe vehicle 11 is the vehicle which committed the stop sign violation, the scoring processing part C32A gives the vehicle sensor data a lower score than when the probe vehicle 11 is not the vehicle which committed the stop sign violation.

In the example shown in FIG. 1 and FIG. 2, the scoring processing part C32A recognizes a stop location of a road on which the probe vehicle 11 is traveling based on an image of the front of the probe vehicle 11 captured by the front camera functioning as the vehicle sensor 11A. Furthermore, when the probe vehicle 11 passes the stop location, the scoring processing part C32A determines whether the probe vehicle 11 committed a stop sign violation based on the speed of the probe vehicle 11 detected by a vehicle speed sensor functioning as the vehicle sensor 11A. The vehicle sensor data to be determined whether to exclude or not includes image including the stop location in the front of the probe vehicle 11 captured by the front camera and the speed of the probe vehicle 11 detected by the vehicle speed sensor.

In another example, the scoring processing part C32A may determine whether the probe vehicle 11 committed the stop sign violation based on positional information of the probe vehicle 11 obtained by the GPS module functioning as the vehicle sensor 11A and map information possessed by the map information unit 11D. In this example, the vehicle sensor information to be determined whether to exclude or not includes the positional information of the probe vehicle 11 obtained by the GPS module (also including speed information of the probe vehicle 11).

Further, in the example shown in FIG. 1 and FIG. 2, the scoring processing part C32A scores the vehicle sensor data based on information showing whether the probe vehicle 11 is a vehicle which committed a speed limit violation. When the probe vehicle 11 is the vehicle which committed the speed limit violation, the scoring processing part C32A gives the vehicle sensor data a lower score than when the probe vehicle 11 is not the vehicle which committed the speed limit violation.

In the example shown in FIG. 1 and FIG. 2, the scoring processing part C32A recognizes speed limit of the road on which the probe vehicle 11 is traveling based on the image of the front of the probe vehicle 11 captured by the front camera functioning as the vehicle sensor 11A. Furthermore, when the probe vehicle 11 is traveling on the road on which the speed limit is set, the scoring processing part C32A determines whether the probe vehicle 11 committed the speed limit violation based on the speed of the probe vehicle 11 detected by the vehicle speed sensor functioning as the vehicle sensor 11A. The vehicle sensor data to be determined whether to exclude or not includes the image showing speed limit sign or marking in the front of the probe vehicle 11 captured by the front camera and the speed of the probe vehicle 11 detected by the speed sensor.

In another example, the scoring processing part C32A may recognize the speed limit and determine whether the probe vehicle 11 committed the speed limit violation based on the positional information of the probe vehicle 11 obtained by the GPS module functioning as the vehicle sensor 11A and the map information possessed by the map information unit 11D. In this example, the vehicle sensor data to be determined whether to exclude or not includes the positional information of the probe vehicle 11 obtained by the GPS module (also including the speed information of the probe vehicle 11).

Furthermore, in the example shown in FIG. 1 and FIG. 2, the scoring processing part C32A scores the vehicle sensor data based on information showing whether a lane departure warning is frequently issued in the probe vehicle 11. When the lane departure warning is frequently issued in the probe vehicle 11, the scoring processing part C32A gives the vehicle sensor data a lower score than when the lane departure warning is not frequently issued in the probe vehicle 11.

In the example of FIG. 1 and FIG. 2, the scoring processing part C32A determines whether the lane departure warning is frequently issued in the probe vehicle 11 based on output history of the lane departure warning by the HMI.

In another example, the vehicle sensor 11A may include, for example, an internal vehicle camera etc. detecting the lane departure warning output by the HMI, and the scoring processing part C32A may determine whether the lane departure warning is frequently issued in the probe vehicle 11 based on the results of detection of the lane departure warning by the internal vehicle camera etc.

Further, in the example shown in FIG. 1 and FIG. 2, the scoring processing part C32A scores the vehicle sensor data based on information showing whether distance or TTC between the probe vehicle 11 and a preceding vehicle is a second threshold value or less. When the distance or the TTC between the probe vehicle 11 and the preceding vehicle is the second threshold value or less, the scoring processing part C32A gives the vehicle sensor data a lower score than when the distance or the TTC between the probe vehicle 11 and the preceding vehicle is not the second threshold value or less.

In the example shown in FIG. 1 and FIG. 2, the second threshold value is set so that only the preceding vehicle is included in the image of the front of the probe vehicle 11 captured by the front camera when the distance or the TTC between the probe vehicle 11 and the preceding vehicle is the second threshold value or less. The scoring processing part C32A determines that the distance or the TTC between the probe vehicle 11 and the preceding vehicle is the second threshold value or less when only the preceding vehicle is included in the image of the front of the probe vehicle 11 captured by the front camera and determines that the distance or the TTC between the probe vehicle 11 and the preceding vehicle is not the second threshold value or less when the preceding vehicle and something other than the preceding vehicle (for example, scenery etc.) are included in the image of the front of the probe vehicle 11 captured by the front camera. The vehicle sensor data to be determined whether to exclude or not includes an image including the preceding vehicle in the front of the probe vehicle 11 captured by the front camera.

In another example, the second threshold value may be set so that a region of a predetermined ratio or more of the image of the front of the probe vehicle 11 captured by the front camera shows the preceding vehicle when the distance or the TTC between the probe vehicle 11 and the preceding vehicle is the second threshold value or less. In this example, the scoring processing part C32A determines that the distance or the TTC between the probe vehicle 11 and the preceding vehicle is the second threshold value or less when the region of the predetermined ratio or more of the image in the front of the probe vehicle 11 captured by the front camera shows the preceding vehicle and determines that the distance or the TTC between the probe vehicle 11 and the preceding vehicle is not the second threshold value or less when a region of less than the predetermined ratio of the image in the front of the probe vehicle 11 captured by the front camera shows the preceding vehicle. In this example as well, the vehicle sensor data to be determined whether to exclude or not includes the image including the preceding vehicle in the front of the probe vehicle 11 captured by the front camera.

In the example shown in FIG. 1 and FIG. 2, the determination part C32B compares the score of the vehicle sensor data given by the scoring processing part C32A and a first threshold value. In more detail, the determination part C32B determines whether the score of the vehicle sensor data given by the scoring processing part C32A is the first threshold value or less.

The filtering processing part C32C performs processing for excluding the vehicle sensor data based on the results of determination of the determination part C32B. When it is determined by the determination part C32B that the score of the vehicle sensor data given by the scoring processing part C32A is higher than the first threshold value, the filtering processing part C32C does not exclude the vehicle sensor data (in more detail, the above-mentioned vehicle sensor data to be determined whether to exclude or not). On the other hand, when it is determined by the determination part C32B that the score of the vehicle sensor data given by the scoring processing part C32A is first threshold value or less, the filtering processing part C32C excludes the vehicle sensor data (the vehicle sensor data to be determined whether to exclude or not).

The communication part 11B sends the vehicle sensor data which is not excluded by the filtering processing part C32C to the server apparatus 12 via the network NW.

That is, in the example shown in FIG. 1 and FIG. 2, when the probe vehicle 11 is the vehicle which committed the stop sign violation, the filtering processing part C32C excludes the vehicle sensor data more easily than when the probe vehicle 11 is not the vehicle which committed the stop sign violation.

Further, when the probe vehicle 11 is the vehicle which committed the speed limit violation, the filtering processing part C32C excludes the vehicle sensor data more easily than when the probe vehicle 11 is not the vehicle which committed the speed limit violation.

Furthermore, when the lane departure warning is frequently issued in the probe vehicle 11, the filtering processing part C32C excludes the vehicle sensor data more easily than when the lane departure warning is not frequently issued in the probe vehicle 11.

Further, when the distance or the TTC between the probe vehicle 11 and the preceding vehicle is the second threshold value or less, the filtering processing part C32C excludes the vehicle sensor data more easily than when the distance or the TTC between the probe vehicle 11 and the preceding vehicle is not the second threshold value or less.

In a modification of the filtering device C32 of the first embodiment, when the probe vehicle 11 is the vehicle which committed the stop sign violation, the scoring processing part C32A gives the vehicle sensor data a higher score than when the probe vehicle 11 is not the vehicle which committed the stop sign violation. Further, when the probe vehicle 11 is the vehicle which committed the speed limit violation, the scoring processing part C32A gives the vehicle sensor data a higher score than when the probe vehicle 11 is not the vehicle which committed the speed limit violation. Furthermore, when the lane departure warning is frequently issued in the probe vehicle 11, the scoring processing part C32A gives the vehicle sensor data a higher score than when the lane departure warning is not frequently issued in the probe vehicle 11. Further, when the distance or the TTC between the probe vehicle 11 and the preceding vehicle is the second threshold value or less, the scoring processing part C32A gives the vehicle sensor data a higher score than when the distance or the TTC between the probe vehicle 11 and the preceding vehicle is not the second threshold value or less.

Further, in the modification of the filtering device C32 of the first embodiment, the determination part C32B determines whether the score of the vehicle sensor data given by the scoring processing part C32A is a third threshold value or more. The filtering processing part C32C does not exclude the vehicle sensor data when it is determined by the determination part C32B that the score of the vehicle sensor data given by the scoring processing part C32A is lower than the third threshold value. On the other hand, the filtering processing part C32C excludes the vehicle sensor data when it is determined by the determination part C32B that the score of the vehicle sensor data given by the scoring processing part C32A is the third threshold value or more.

In the modification of the filtering device C32 of the first embodiment as well, the communication part 11B sends the vehicle sensor data which is not excluded by the filtering processing part C32C to the server apparatus 12 via the network NW.

In the example shown in FIG. 1 and FIG. 2, the determination part C32B determines whether a mounting position of the vehicle sensor 11A is changed.

Specifically, the determination part C32B determines whether the mounting position of the in-vehicle camera is changed based on an image after changing the mounting position which is an image showing an external condition of the probe vehicle 11 captured by the in-vehicle camera as the vehicle sensor 11A after the mounting position is changed (for example, when the driver of the probe vehicle 11 is driving the probe vehicle 11 etc.) and an image before changing the mounting position which is an image showing the external condition of the probe vehicle 11 captured by the in-vehicle camera before the mounting position changes (for example, at the time of inspection of the probe vehicle 11 before shipment etc.). The determination part C32B uses known image comparing techniques to determine whether the mounting position of the in-vehicle camera is changed. For example, when modification is made to lower the height of the probe vehicle 11 etc., the determination part C32B determines that the mounting position of the in-vehicle camera is changed.

Further, the determination part C32B determines whether the mounting position of the LiDAR is changed based on the results of object recognition performed by the LiDAR at the time of calibration of the LiDAR as the vehicle sensor 11A (for example, at the time of the inspection of the probe vehicle 11 etc.) after the mounting position is changed and the results of object recognition performed by the LiDAR at the time of calibration of the LiDAR (for example, at the time of the inspection of the probe vehicle 11 before shipment etc.) before the mounting position is changed. The determination part C32B uses a known point cloud comparing technique to determine whether the mounting position of the LiDAR is changed. For example, when modification of fenders, tires, etc. of the probe vehicle 11 is made, the determination part C32B determines that the mounting position of the LiDAR is changed.

When the mounting position of the vehicle sensor 11A is changed, the filtering processing part C32C performs processing for excluding the vehicle sensor data after the mounting position of the vehicle sensor 11A is changed which shows the results of detection of the vehicle sensor 11A after the mounting position is changed.

Specifically, the filtering processing part C32C performs processing for excluding the image after changing the mounting position as the vehicle sensor data when the determination part C32B determines that the mounting position of the in-vehicle camera is changed.

Further, when the determination part C32B determines that the mounting position of the LiDAR as the vehicle sensor 11A is changed, the filtering processing part C32C performs processing for excluding the vehicle sensor data after the mounting position of the vehicle sensor 11A is changed which is the results of object recognition performed by the LiDAR after the determination part C32B determines that the mounting position of the LiDAR is changed.

In the example shown in FIG. 1 and FIG. 2, the server apparatus 12 has the function of collecting the vehicle sensor data (in more detail, the vehicle sensor data which is not excluded by the filtering processing part C32C) obtained in the probe vehicle 11. The server apparatus 12, for example, is configured by a computer having CPU (central processing unit), memory, storage, NIC (network interface card), etc. The server apparatus 12 is provided with communication part 12A, storage part 12B, and control part 12C.

For example, the NIC has the function of the communication part 12A. The communication part 12A receives the vehicle sensor data sent by the communication part 11B of the probe vehicle 11 through the network NW. Further, the communication part 12A, for example, sends the vehicle sensor data collected by the server apparatus 12 to the map information generating device 13 through the network NW in response to a request from the map information generating device 13 etc.

For example, a RAM (random access memory), ROM (read only memory), or other memory and, for example, HDD, SSD, or other storage has the function as the storage part 12B. The storage part 12B stores the vehicle sensor data received by the communication part 12A (the vehicle sensor data which is not excluded by filtering processing part C32C of probe vehicle 11).

For example, the CPU functions as the control part 12C. The control part 12C, for example, performs processing for making the communication part 12A receive the vehicle sensor data (the vehicle sensor data which is not excluded by filtering processing part C32C) sent by the communication part 11B of the probe vehicle 11, processing for making the storage part 12B store the vehicle sensor data received by the communication part 12A, etc. Further, the control part 12C, for example, performs processing for making the communication part 12A send the vehicle sensor data to the map information generating device 13 through the network NW in response to the request from the map information generating device 13 etc.

The map information generating device 13 has the function of generating the map information based on the vehicle sensor data obtained in the probe vehicle 11.

For example, the map information generating device 13 uses the vehicle sensor data (the vehicle sensor data which is not excluded by filtering processing part C32C) showing information on road on which the probe vehicle 11 actually traveled in the last 24 hours to generate the map information showing a road which can actually be traveled.

As explained above, in the first example of the vehicle data utilization system 1 to which the filtering device C32 of the first embodiment is applied, the vehicle sensor data which is not excluded by the filtering processing part C32C is used for generation of the map information in the map information generating device 13.

In a second example of the vehicle data utilization system 1 to which the filtering device C32 of the first embodiment is applied, the vehicle sensor data which is not excluded by the filtering processing part C32C may be used for generation of traffic information in a traffic information generating apparatus (not shown).

In the second example of the vehicle data utilization system 1 to which the filtering device C32 of the first embodiment is applied, by traveling of the probe vehicle 11, the traffic information relating to the road on which the probe vehicle 11 traveled is generated by the traffic information generating apparatus. The traffic information generated by the traffic information generating apparatus can be added to the traffic information of main roads by a road traffic information communication system to thereby enable route guidance covering a broad range of roads based on more abundant real time information. Further, by the traffic information generating apparatus analyzing the traffic information of a certain time period, use for reducing congestion, promoting tourism, and solving other local issues can also be expected.

In a third example of the vehicle data utilization system 1 to which the filtering device C32 of the first embodiment is applied, the vehicle sensor data which is not excluded by the filtering processing part C32C may be used for generation of information showing deterioration condition of road surfaces in a road surface deterioration condition information generating apparatus (not shown).

This is because grasping the condition of roads leads to not only maintaining convenience in daily life, but also prevention of accidents in advance, securing evacuation routes at the times of earthquakes or other disasters, and other enhanced safety and security.

In the maintenance and management of roads, the local government in charge of road management has to obtain a grasp roads to be repaired in advance by routine patrols, periodic surveys, etc. By applying the technique of analyzing the vehicle sensor data (the vehicle sensor data which is not excluded by filtering processing part C32C) obtained from the probe vehicle 11, it becomes possible to convert deteriorated conditions of road surfaces into numerical values and possible to study plans for maintenance and inspection, priorities, etc. Due to this, the expense, trouble, etc. of the local government surveying the roads are reduced. Further, by the roads being maintained, repaired, etc., a richer mobile society can be expected to be led to.

FIG. 3 is a flow chart for explaining one example of processing performed by the filtering device C32 of the first embodiment.

In the example shown in FIG. 3, at step S11, the scoring processing part C32A scores the vehicle sensor data (the vehicle sensor data showing the results of detection of the vehicle sensor 11A) collected by the collecting device C31 from the vehicle sensor 11A. Specifically, the scoring processing part C32A scores the vehicle sensor data based on the information showing whether the probe vehicle 11 is the vehicle which committed the stop sign violation. Further, the scoring processing part C32A scores the vehicle sensor data based on the information showing whether the probe vehicle 11 is the vehicle which committed the speed limit violation. Furthermore, the scoring processing part C32A scores the vehicle sensor data based on the information showing whether the lane departure warning is frequently issued in the probe vehicle 11. Further, the scoring processing part C32A scores the vehicle sensor data based on the information showing whether the distance or the TTC between the probe vehicle 11 and the preceding vehicle is the second threshold value or less.

In another example, the scoring processing part C32A may score the vehicle sensor data based on at least one of the information showing whether the probe vehicle 11 is the vehicle which committed the stop sign violation, the information showing whether probe vehicle 11 is the vehicle which committed the speed limit violation, the information showing whether the lane departure warning is frequently issued in the probe vehicle 11, and the information showing whether the distance or the TTC between the probe vehicle 11 and the preceding vehicle is the second threshold value or less.

In the example shown in FIG. 3, at step S12, the determination part C32B compares the score of the vehicle sensor data given at step S11 and the first threshold value. In more detail, the determination part C32B determines whether the score of the vehicle sensor data given at step S11 is the first threshold value or less. When the score of the vehicle sensor data is the first threshold value or less, the routine proceeds to step S13. When the score of the vehicle sensor data is not the first threshold value or less, the routine shown in FIG. 3 is ended.

At step S13, the filtering processing part C32C performs the processing for excluding the vehicle sensor data.

As explained above, in the vehicle data utilization system 1 to which the filtering device C32 of the first embodiment is applied, when the probe vehicle 11 is the vehicle which committed the stop sign violation, the vehicle sensor data showing the results of detection of the vehicle sensor 11A mounted in the probe vehicle 11 becomes easier to be excluded than when the probe vehicle 11 is not the vehicle which committed the stop sign violation. Further, when the probe vehicle 11 is the vehicle which committed the speed limit violation, the vehicle sensor data becomes easier to be excluded than when the probe vehicle 11 is not the vehicle which committed the speed limit violation. Further, when the lane departure warning is frequently issued in the probe vehicle 11, the vehicle sensor data becomes easier to be excluded than when the lane departure warning is not frequently issued in the probe vehicle 11. Further, when the distance or the TTC between the probe vehicle 11 and the preceding vehicle is the second threshold value or less, the vehicle sensor data becomes easier to be excluded than when the distance or the TTC between the probe vehicle 11 and the preceding vehicle is not the second threshold value or less.

That is, in the vehicle data utilization system 1 to which the filtering device C32 of the first embodiment is applied, the vehicle sensor data which should not be utilized in the map information generating device 13 etc. due to the nature of the driver of the probe vehicle 11 is excluded by the filtering device C32. For this reason, in the vehicle data utilization system 1 to which the filtering device C32 of the first embodiment is applied, it becomes possible to generate the map information etc. reflecting the vehicle sensor data (the vehicle sensor data which is not excluded by filtering processing part C32C) having a high reliability.

Further, in the vehicle data utilization system 1 to which the filtering device C32 of the first embodiment is applied, when the mounting position of the vehicle sensor 11A is changed, the vehicle sensor data after the mounting position of the vehicle sensor 11A is changed which shows the results of detection of the vehicle sensor 11A after the mounting position is changed is excluded.

That is, in the vehicle data utilization system 1 to which the filtering device C32 of the first embodiment is applied, the vehicle sensor data (the vehicle sensor data after the mounting position of the vehicle sensor 11A is changed) which should not be utilized in the map information generating device 13 etc. due to the nature of owner of the probe vehicle 11 etc. is excluded by the filtering device C32. For this reason, in the vehicle data utilization system 1 to which the filtering device C32 of the first embodiment is applied, it becomes possible to generate the map information etc. reflecting the vehicle sensor data (the vehicle sensor data which does not include the vehicle sensor data after the mounting position of the vehicle sensor 11A is changed) having a high reliability.

The above-mentioned processing by the determination part C32B of the filtering device C32 etc. may be performed in real time (that is, at the timing where the vehicle sensor data is collected by the collection device C31), but may also be performed each time the probe vehicle 11 travels a certain distance.

As explained above, in the example shown in FIG. 1 and FIG. 2, the map information generating device 13 uses the vehicle sensor data which is not excluded by the filtering processing part C32C (that is, the vehicle sensor data after the processing by the determination part C32B etc. is performed) to generate the map information, but in another example (for example, in an example where the map information having a high precision is not demanded), the map information generating device 13 may also use the vehicle sensor data before the processing by the determination part C32B etc. is performed so as to generate the map information.

In the example shown in FIG. 1 and FIG. 2, to set the first threshold value used for the comparison with the score of the vehicle sensor data, first a plurality of probe vehicles 11 able to collect the vehicle sensor data (probe information) are extracted as samples. Next, the score is given to the vehicle sensor data of each of the plurality of probe vehicles 11 extracted as samples. Furthermore, the first threshold value is set by using the deviation of the distribution of the plurality of the score of the vehicle sensor data etc.

The scoring processing part C32A changes the weighting corresponding to the values by which the probe vehicles 11 exceeded the speed limits and scores the vehicle sensor data at the time of scoring the vehicle sensor data based on the information showing whether the probe vehicle 11 is the vehicle which violated the speed limits. Specifically, the scoring processing part C32A makes the score to be reduced corresponding to the vehicle sensor data of the probe vehicle 11 exceeding the speed limit by 20 km/h higher than twice the score to be reduced corresponding to the vehicle sensor data of the probe vehicle 11 exceeding the speed limit by 10 km/h.

Further, the scoring processing part C32A raises the score to be reduced in accordance with the time the lane departure warning is output (for example proportionally) when the scoring processing part C32A scores the vehicle sensor data based on the information showing whether the lane departure warning is frequently issued in the probe vehicle 11. When the time the lane departure warning is output is short, the score to be reduced corresponding to the vehicle sensor data is low, so the score of the vehicle sensor data does not reach the first threshold value or less and the filtering processing part C32C does not exclude the vehicle sensor data.

Even if the filtering processing part C32C performed the processing for excluding the vehicle sensor data of the probe vehicle 11, after the filtering processing part C32C performed the processing for excluding the vehicle sensor data of the probe vehicle 11 and when the state where the score of the vehicle sensor data of the probe vehicle 11 was not the first threshold value or less continued for a predetermined time period or more, the vehicle sensor data of the probe vehicle 11 becomes to be used again to generate the map information in the map information generating device 13 without being excluded by the filtering processing part C32C.

### Second Embodiment

The vehicle data utilization system 1 to which the filtering device 2C2 of a second embodiment is applied is configured in the same way as the above-mentioned vehicle data utilization system 1 to which the filtering device C32 of the first embodiment is applied except for the score explained later.

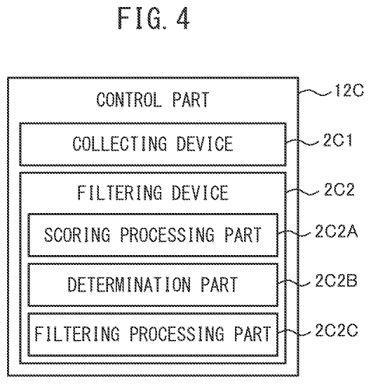

FIG. 4 is a view showing one example of the function of the control part 12C of the server apparatus 12 of the vehicle data utilization system 1 to which the filtering device 2C2 of the second embodiment is applied.

As explained above, in the first example (the example shown in FIG. 1 and FIG. 2) of the vehicle data utilization system 1 to which the filtering device C32 of the first embodiment is applied, the filtering device C32 is provided in the probe vehicle 11.

On the other hand, in the first example (the example shown in FIG. 1 and FIG. 4) of the vehicle data utilization system 1 to which the filtering device 2C2 of the second embodiment is applied, the filtering device 2C2 is provided in the server apparatus 12.

In the example shown in FIG. 1 and FIG. 4, unlike the example shown in FIG. 1 and FIG. 2, the processor C3 does not have the function as the collecting device and the function as the filtering device. In the example shown in FIG. 1 and FIG. 4, instead, the control part 12C of the server apparatus 12 has the function as the collecting device 2C1 and the function as the filtering device 2C2.

In the example shown in FIG. 1 and FIG. 4, the communication part 11B of the probe vehicle 11 sends the vehicle sensor data showing the results of detection of the vehicle sensor 11A through the network NW to the server apparatus 12. The communication part 12A of the server apparatus 12 receives the vehicle sensor data sent by the communication part 11B of the probe vehicle 11. The collecting device 2C1 of the control part 12C of the server apparatus 12 collects the vehicle sensor data received by the communication part 12A of the server apparatus 12.

The vehicle sensor data collected by the collecting device 2C1 may include, for example, the vehicle sensor data which is not appropriate for being utilized by the map information generating device 13 etc.

In view of this point, in the example shown in FIG. 1 and FIG. 4, the control part 12C of the server apparatus 12 has the function of the filtering device 2C2 which performs the processing for excluding the vehicle sensor data. The filtering device 2C2 is provided with the scoring processing part 2C2A, the determination part 2C2B, and the filtering processing part 2C2C.

The scoring processing part 2C2A scores the vehicle sensor data collected by the collecting device 2C1.

Specifically, the scoring processing part 2C2A scores the vehicle sensor data based on the information showing whether the probe vehicle 11 is the vehicle which committed the stop sign violation. When the probe vehicle 11 is the vehicle which committed the stop sign violation, the scoring processing part 2C2A gives the vehicle sensor data the lower score than when the probe vehicle 11 is not the vehicle which committed the stop sign violation.

Further, the scoring processing part 2C2A scores the vehicle sensor data based on the information showing whether the probe vehicle 11 is the vehicle which committed the speed limit violation. When the probe vehicle 11 is the vehicle which committed the speed limit violation, the scoring processing part 2C2A gives the vehicle sensor data the lower score than when the probe vehicle 11 is not the vehicle which committed the speed limit violation.

Furthermore, the scoring processing part 2C2A scores the vehicle sensor data based on the information showing whether the lane departure warning is frequently issued in the probe vehicle 11. When the lane departure warning is frequently issued in the probe vehicle 11, the scoring processing part 2C2A gives the vehicle sensor data the lower score than when the lane departure warning is not frequently issued in the probe vehicle 11.

Further, the scoring processing part 2C2A scores the vehicle sensor data based on the information showing whether the distance or the TTC between the probe vehicle 11 and the preceding vehicle is the second threshold value or less. When the distance or the TTC between the probe vehicle 11 and the preceding vehicle is the second threshold value or less, the scoring processing part 2C2A gives the vehicle sensor data the lower score than when the distance or the TTC between the probe vehicle 11 and the preceding vehicle is not the second threshold value or less.

In the example shown in FIG. 1 and FIG. 4, the determination part 2C2B compares the score of the vehicle sensor data given by the scoring processing part 2C2A and the first threshold value. In more detail, the determination part 2C2B determines whether the score of the vehicle sensor data given by the scoring processing part 2C2A is the first threshold value or less.

The filtering processing part 2C2C performs the processing for excluding the vehicle sensor data based on the results of determination of the determination part 2C2B. The filtering processing part 2C2C does not exclude the vehicle sensor data when it is determined by the determination part 2C2B that the score of the vehicle sensor data given by the scoring processing part 2C2A is higher than the first threshold value. On the other hand, the filtering processing part 2C2C excludes the vehicle sensor data when it is determined by the determination part 2C2B that the score of the vehicle sensor data given by the scoring processing part 2C2A is the first threshold value or less.

Further, in the example shown in FIG. 1 and FIG. 4, the determination part 2C2B determines whether the mounting position of the vehicle sensor 11A is changed.

The filtering processing part 2C2C performs the processing for excluding the vehicle sensor data after the mounting position of the vehicle sensor 11A is changed which shows the results of detection of the vehicle sensor 11A after the mounting position is changed when the mounting position of the vehicle sensor 11A is changed.

Specifically, the filtering processing part 2C2C performs the processing for excluding the image after changing the mounting position as the vehicle sensor data when the determination part 2C2B determines that the mounting position of the in-vehicle camera is changed.

Further, the filtering processing part 2C2C performs the processing for excluding the vehicle sensor data after the mounting position of the vehicle sensor 11A is changed which is the results of object recognition performed by the LiDAR after the determination part 2C2B determines that the mounting position of the LiDAR is changed when the determination part 2C2B determines that the mounting position of the LiDAR as the vehicle sensor 11A is changed.

The storage part 12B of the server apparatus 12 stores the vehicle sensor data which is not excluded by the filtering processing part 2C2C.

Further, the control part 12C of the server apparatus 12, for example, performs the processing for making the communication part 12A send the vehicle sensor data (the vehicle sensor data which is not excluded by the filtering processing part 2C2C) through the network NW to the map information generating device 13 in response to the request from the map information generating device 13 etc.

The map information generating device 13 uses the vehicle sensor data (the vehicle sensor data which is not excluded by filtering processing part 2C2C) to thereby generate the map information.

As explained above, in the first example of the vehicle data utilization system 1 to which the filtering device 2C2 of the second embodiment is applied, the vehicle sensor data which is not excluded by the filtering processing part 2C2C is used for generation of the map information in the map information generating device 13.

In a second example of the vehicle data utilization system 1 to which the filtering device 2C2 of the second embodiment is applied, the vehicle sensor data which is not excluded by the filtering processing part 2C2C may be used for generation of the traffic information in the traffic information generating device (not shown).

In a third example of the vehicle data utilization system 1 to which the filtering device 2C2 of the second embodiment is applied, the vehicle sensor data which is not excluded by the filtering processing part 2C2C may be used for generation of the information showing the deterioration condition of the road surfaces in the road surface deterioration condition information generating device (not shown).

In the above way, embodiments of the filtering device, the filtering method, and the non-transitory recording medium of the present disclosure were explained referring to the drawings, but the filtering device, the filtering method, and the non-transitory recording medium of the present disclosure are not limited to the above-mentioned embodiments and can be suitably changed in a scope not departing from the gist of the present disclosure. The configurations of the examples of the embodiments explained above may also be suitably combined.

In the examples of the above-mentioned embodiments, the processing performed in the filtering devices C32 and 2C2 were explained as software processing performed by running a program stored in the memory C2 or the storage part 12B, but the processing performed in the filtering devices C32 and 2C2 may also be processing performed by hardware. Alternatively, the processing performed by the filtering devices C32 and 2C2 may also be processing combining both software and hardware. Further, the program stored in the memory C2 of the control part 11C (the program realizing functions of the processor C3 of the control part 11C) or the program stored in the storage part 12B of the server apparatus 12 (the program realizing functions of the control part 12C of the server apparatus 12) may also, for example, be provided, distributed, etc. recorded in semiconductor memory, magnetic recording medium, optical recording medium or other such computer readable storage medium (non-transitory recording medium).

1. A filtering device comprising a processor configured to:
perform processing for excluding vehicle sensor data showing results of detection of a vehicle sensor mounted in a probe vehicle;
score the vehicle sensor data, and
compare score of the vehicle sensor data and a first threshold value,
wherein the processor is configured to perform the processing for excluding the vehicle sensor data based on results of comparison of the score of the vehicle sensor data and the first threshold value, and
the processor is configured to score the vehicle sensor data based on at least one of information showing whether the probe vehicle is a vehicle which committed a stop sign violation, information showing whether the probe vehicle is a vehicle which committed a speed limit violation, information showing whether a lane departure warning is frequently issued in the probe vehicle, and information showing whether a distance or a TTC (time to collision) between the probe vehicle and a preceding vehicle is a second threshold value or less.

2. The filtering device according to claim 1, wherein
the processor is configured to score the vehicle sensor data based on the information showing whether the probe vehicle is the vehicle which committed the stop sign violation, and
when the probe vehicle is the vehicle which committed the stop sign violation, the processor is configured to exclude the vehicle sensor data more easily than when the probe vehicle is not the vehicle which committed the stop sign violation.

3. The filtering device according to claim 1, wherein
the processor is configured to score the vehicle sensor data based on the information showing whether the probe vehicle is the vehicle which committed the speed limit violation, and
when the probe vehicle is the vehicle which committed the speed limit violation, the processor is configured to exclude the vehicle sensor data more easily than when the probe vehicle is not the vehicle which committed the speed limit violation.

4. The filtering device according to claim 1, wherein
the processor is configured to score the vehicle sensor data based on the information showing whether the lane departure warning is frequently issued in the probe vehicle, and
when the lane departure warning is frequently issued in the probe vehicle, the processor is configured to exclude the vehicle sensor data more easily than when the lane departure warning is not frequently issued in the probe vehicle.

5. The filtering device according to claim 1, wherein
the processor is configured to score the vehicle sensor data based on the information showing whether the distance or the TTC between the probe vehicle and the preceding vehicle is the second threshold value or less, and
when the distance or the TTC between the probe vehicle and the preceding vehicle is the second threshold value or less, the processor is configured to exclude the vehicle sensor data more easily than when the distance or the TTC between the probe vehicle and the preceding vehicle is not the second threshold value or less.

6. The filtering device according to claim 1, wherein
the vehicle sensor includes a front camera capturing an image of the front of the probe vehicle,
the vehicle sensor data includes the image of the front of the probe vehicle captured by the front camera, and
when the distance or the TTC between the probe vehicle and the preceding vehicle is the second threshold value or less, the image of the front of the probe vehicle captured by the front camera includes only the preceding vehicle or most of the image of the front of the probe vehicle captured by the front camera shows the preceding vehicle.

7. The filtering device according to claim 1, wherein
the processor is configured to determine whether a mounting position of the vehicle sensor is changed, and
when the mounting position of the vehicle sensor is changed, the processor is configured to perform processing for excluding vehicle sensor data after changing the mounting position which shows results of detection of the vehicle sensor after the mounting position is changed.

8. The filtering device according to claim 7, wherein
the vehicle sensor includes an in-vehicle camera capturing an image showing an external condition of the probe vehicle,
the processor is configured to determine whether the mounting position of the in-vehicle camera is changed based on an image after changing the mounting position which is an image showing the external condition of the probe vehicle captured by the in-vehicle camera after the mounting position is changed and an image before changing the mounting position which is an image showing the external condition of the probe vehicle captured by the in-vehicle camera before the mounting position changes, and
the processor is configured to perform processing for excluding the image after changing the mounting position when the mounting position of the in-vehicle camera is changed.

9. The filtering device according to claim 7, wherein
the vehicle sensor includes a LiDAR having a function of recognizing an object outside the probe vehicle,
the processor is configured to determine whether a mounting position of the LiDAR is changed based on the results of object recognition performed by the LiDAR at the time of calibration of the LiDAR after the mounting position is changed and the results of object recognition performed by the LiDAR at the time of the calibration of the LiDAR before the mounting position is changed, and
the processor is configured to perform processing for excluding the results of object recognition performed by the LiDAR after determining that the mounting position of the LiDAR is changed when the processor determines that the mounting position of the LiDAR is changed.

10. The filtering device according to claim 1, wherein
the vehicle sensor data which is not excluded by the processor is used for at least one of generation of map information, generation of traffic information, and generation of information showing deteriorated condition of road surface.

11. A filtering method comprising:
performing processing for excluding vehicle sensor data showing results of detection of a vehicle sensor mounted in a probe vehicle,
scoring the vehicle sensor data, and
comparing score of the vehicle sensor data and a first threshold value,
wherein the processing for excluding the vehicle sensor data is performed based on results of comparison of the score of the vehicle sensor data and the first threshold value, and
the vehicle sensor data is scored based on at least one of information showing whether the probe vehicle is a vehicle which committed a stop sign violation, information showing whether the probe vehicle is a vehicle which committed a speed limit violation, information showing whether a lane departure warning is frequently issued in the probe vehicle, and information showing whether a distance or a TTC between the probe vehicle and a preceding vehicle is a second threshold value or less.

12. A non-transitory recording medium having recorded thereon a computer program for causing a computer mounted in a probe vehicle or a computer forming a server device to execute a process comprising:
scoring vehicle sensor data showing results of detection of a vehicle sensor mounted in the probe vehicle,
comparing score of the vehicle sensor data and a first threshold value, and
performing processing for excluding the vehicle sensor data based on the results of comparison of the score of the vehicle sensor data and the first threshold value,
wherein the vehicle sensor data is scored based on at least one of information showing whether the probe vehicle is a vehicle which committed a stop sign violation, information showing whether the probe vehicle is a vehicle which committed a speed limit violation, information showing whether a lane departure warning is frequently issued in the probe vehicle, and information showing whether a distance or a TTC between the probe vehicle and a preceding vehicle is a second threshold value or less.
